(19) United States
(12) Patent Application Publication
(10) Pub. No.: US 2023/0363022 A1
(43) Pub. Date: Nov. 9, 2023

(54) COMMUNICATION SYSTEM, COMMUNICATION APPARATUS AND METHOD OF CONTROLLING THE SAME, AND STORAGE MEDIUM

(71) Applicant: Canon Kabushiki Kaisha, Tokyo (JP)

(72) Inventor: KEI TAKARABE, Kanagawa (JP)

(21) Appl. No.: 18/309,881

(22) Filed: May 1, 2023

(30) Foreign Application Priority Data
May 9, 2022 (JP) 2022-077179

(51) Int. Cl. H04W 76/10; G06K 19/06; H04W 12/04

(52) U.S. Cl. CPC H04W 76/10; G06K 19/06037; H04W 12/04; H04W 84/12

(57) ABSTRACT

A communication apparatus presents information necessary for wireless setting to a user based on a condition for having entered a state in which the wireless setting for performing wireless communication with an information processing apparatus is able to be started being a first condition, displays a screen including information indicating that the wireless setting is able to be started, based on the condition for having entered the state in which the wireless setting is able to be started being a second condition, and in response to an instruction of the user via the screen, presents the information necessary for the wireless setting to the user. The communication apparatus receives a request for the wireless setting from the information processing apparatus that has obtained connection information based on the presented information presented and executes the wireless setting in response to the received request.

### BACKGROUND OF THE INVENTION

### Field of the Invention

The present invention relates to a communication system, a communication apparatus and a method of controlling the same, and a storage medium.

### Description of the Related Art

A technique for connecting a communication apparatus, such as a printer, and an access point (external apparatus) by an information processing apparatus, such as a personal computer (PC), transmitting information related to the external apparatus to the communication apparatus is known.

Japanese Patent Laid-Open No. 2019-180036 describes setup processing for connecting a communication apparatus and an access point by the communication apparatus displaying a QR code® on an operation panel of the communication apparatus upon receiving a specific signal from an information processing apparatus and the information processing apparatus reading the displayed QR code. However, with this method, since a malicious third party can cause a QR code to be displayed on the operation panel of the communication apparatus, there is a risk that operation of the communication apparatus will be interfered with due to the communication apparatus being connected to an information processing apparatus of the malicious third party, or the like.

In recent years, with the popularization of a function for connecting a communication apparatus and an access point by transmitting connection information for connecting the communication apparatus and the access point, there has been a demand for improvement in the convenience of that function.

### SUMMARY OF THE INVENTION

Embodiments of the present disclosure eliminate the above-mentioned issues with conventional technology.

A feature of embodiments of the present disclosure is to control presentation of information necessary for wireless setting to a user without reducing usability.

According to embodiments of the present disclosure, there is provided a communication apparatus operable to communicate with an information processing apparatus, the communication apparatus comprising: one or more memories storing instructions; and one or more processors that execute the instructions to: present information necessary for wireless setting to a user based on a condition for having entered a state in which the wireless setting for performing wireless communication with the information processing apparatus is able to be started being a first condition, display a screen including information indicating that the wireless setting is able to be started, based on the condition for having entered the state in which the wireless setting is able to be started being a second condition different from the first condition, and in response to an instruction of the user via the screen, present the information necessary for the wireless setting to the user, receive a request for the wireless setting from the information processing apparatus that has obtained connection information based on the information presented based on the condition being the first condition or the information presented in response to the instruction of the user via the screen, and execute the wireless setting in response to the received request.

According to embodiments of the present disclosure, there is provided a communication system including an information processing apparatus and a communication apparatus, the communication apparatus comprising: one or more first memories storing instructions; and one or more first processors that execute the instructions to: present information necessary for wireless setting to a user based on a condition for entering a state in which the wireless setting for performing wireless communication with the information processing apparatus is able to be started being a first condition, display a screen including information indicating that the wireless setting is able to be started, based on the condition for entering the state in which the wireless setting can be started being a second condition different from the first condition, and in response to an instruction of the user, present the information necessary for the wireless setting to the user via the screen, receive a request for the wireless setting from the information processing apparatus that has obtained connection information based on the information presented based on the condition being the first condition or the information presented in response to the instruction of the user via the screen, and execute the wireless setting in response to the received request, the information processing apparatus, comprising: one or more second memories storing instructions; and one or more second processors that execute the instructions to: obtain the information necessary for the wireless setting by capturing an image of the information presented based on the condition being the first condition or the information presented in response to the instruction of the user via the screen, and obtain the connection information based on the obtained information and information of an access point to be set, and transmit as the request for the wireless setting the connection information to the communication apparatus.

Further features of the present disclosure will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the disclosure and, together with the description, serve to explain the principles of the disclosure.

FIG. 1 is a block diagram for describing configurations of an information processing apparatus and a communication apparatus according to an embodiment of the present invention.

FIG. 2 is a sequence diagram for describing communication processing executed by the information processing apparatus and the communication apparatus according to the embodiment using WEC in which DPP is used.

FIG. 3 is a diagram for describing an example of a WEC start screen displayed by the information processing apparatus according to the embodiment via a WEC application.

FIG. 4 is a flowchart for explaining DPP listen mode start processing performed by the communication apparatus according to the embodiment in step S200 of FIG. 2.

FIG. 5 is a flowchart for explaining WEC execution processing executed by the communication apparatus according to the embodiment from step S203 to step S206 of FIG. 2.

FIG. 6 is a flowchart for explaining network setup processing in the communication apparatus according to the embodiment.

FIG. 7 is a diagram illustrating an example of a screen displayed on a display unit of the communication apparatus in step S604 of FIG. 6.

FIGS. 8A to 8D illustrate diagrams of examples of screens displaying that a network setup mode has been started in step S609 of FIG. 6.

FIG. 9 is a diagram illustrating an example of a selection screen displayed on the display unit of the communication apparatus in step S611 of FIG. 6.

### DESCRIPTION OF THE EMBODIMENTS

Embodiments of the present disclosure will be described hereinafter in detail, with reference to the accompanying drawings. It is to be understood that the following embodiments are not intended to limit the claims of the present disclosure, and that not all of the combinations of the aspects that are described according to the following embodiments are necessarily required with respect to the means to solve the issues according to the present disclosure.

An information processing apparatus and a communication apparatus included in a communication system according to an embodiment of the present invention will be described. In the present embodiment, a smartphone is given as an example of the information processing apparatus; however, the information processing apparatus is not limited to this. For example, various apparatuses, such as a mobile terminal, a personal computer (PC), a tablet terminal, a personal digital assistant (PDA), and a digital camera, are applicable to the information processing apparatus. Further, in the embodiment, a printer is given as an example of the communication apparatus; however, the communication apparatus is not limited to this, and various apparatuses are applicable so long as the apparatuses are capable of performing wireless communication with the information processing apparatus. For example, if the communication apparatus is a printer, the communication apparatus is applicable to an ink jet printer, a full-color laser beam printer, a monochrome printer, and the like. The communication apparatus is applicable not only to a printer but also to a copy machine, a facsimile apparatus, a mobile terminal, a smartphone, a notebook PC, a tablet, a PDA, a digital camera, a music playback device, a TV, a smart speaker, and the like. The communication apparatus is also applicable to a multifunction peripheral provided with a plurality of functions, such as a copying function, a FAX function, and a print function.

In the embodiment, when the information processing apparatus supports a function called Wi-Fi Easy Connect (hereinafter, WEC)®, the information processing apparatus can execute that function. WEC is a function for executing network setup (wireless setting) of another apparatus using Device Provisioning Protocol (hereinafter, DPP) formulated by Wi-Fi Alliance. The network setup of another apparatus is, specifically, processing for connecting another apparatus with an access point forming a network. In WEC, communication is performed between an apparatus (hereinafter, referred to as a Configurator apparatus) operating in a role of a “Configurator” and an apparatus (hereinafter, referred to as an Enrollee apparatus) operating in a role of an “Enrollee”. In the present embodiment, assume that a Configurator apparatus is an Initiator in DPP and an Enrollee apparatus is a Responder in DPP.

A Configurator apparatus obtains bootstrapping information from an Enrollee apparatus. The bootstrapping information includes, for example, identification information (such as a MAC address) of the Enrollee apparatus, public key used for performing secure communication with the Enrollee apparatus, and the like. In the present embodiment, the bootstrapping information will be described as “WEC-related information”. Other information may also be treated as the WEC-related information. The Configurator apparatus then performs wireless communication with the Enrollee apparatus using the obtained bootstrapping information. Specifically, for example, the Configurator apparatus communicates with the Enrollee apparatus using a public key included in the bootstrapping information. Furthermore, the Configurator apparatus generates a common key based on information obtained by the communication and transmits information encrypted using the common key to the Enrollee apparatus. The information transmitted here specifically is, for example, connection information for connecting to an access point. The Enrollee apparatus then establishes a wireless connection with the access point using the connection information received from the Configurator apparatus. Descriptions will be given assuming that an information processing apparatus supporting WEC operates as the Configurator apparatus and a communication apparatus supporting WEC operates as the Enrollee apparatus in the network setup processing according to WEC in the present embodiment.

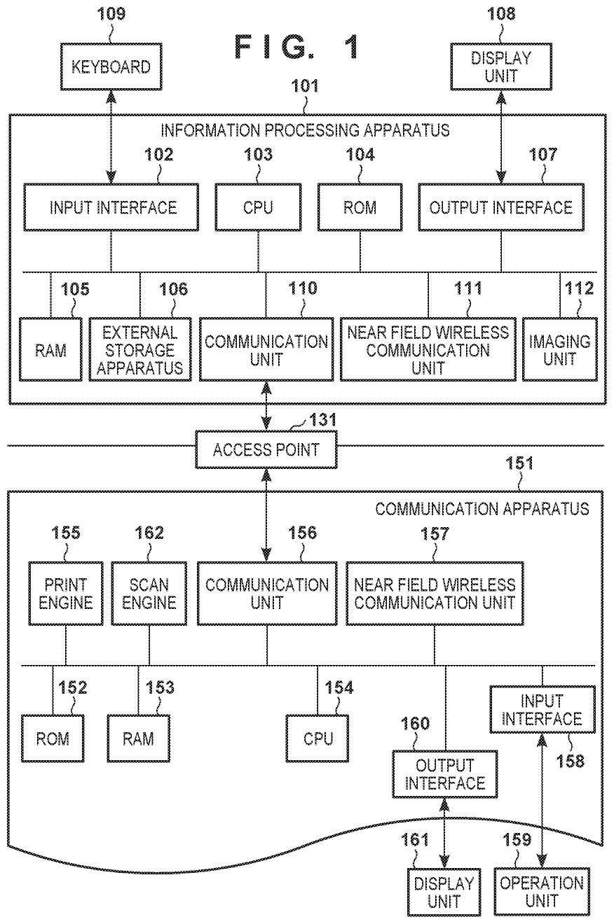

First, configurations of an information processing apparatus according to the embodiment and a communication apparatus capable of communicating with the information processing apparatus according to the embodiment will be described with reference to a block diagram of FIG. 1. Further, although descriptions will be given in the embodiment using the following configurations as examples, the present embodiment is applicable to an apparatus capable of communicating with a communication apparatus and, in particular, does not limit functions to what is illustrated in FIG. 1.

FIG. 1 is a block diagram for describing configurations of an information processing apparatus 101 and a communication apparatus 151 according to the embodiment of the present invention.

First, the configuration of the information processing apparatus 101 will be described.

The information processing apparatus 101 is an information processing apparatus according to the present disclosure. The information processing apparatus 101 includes an input interface 102, a CPU 103, ROM 104, a RAM 105, an external storage apparatus 106, an output interface 107, a display unit 108, a communication unit 110, a near field wireless communication unit 111, and the like. A control unit of the information processing apparatus 101 is formed by the CPU 103, the ROM 104, the RAM 105, and the like.

The input interface 102 is an interface for accepting data input and operation instructions from a user by an operation unit, such as a keyboard 109, being operated. The operation unit may be a physical keyboard, a physical button, and the like or a software keyboard, a software button, and the like displayed on the display unit 108. That is, the input interface 102 may accept input (an operation) from the user via the display unit 108.

The CPU 103 functions as a system control unit and controls the entire information processing apparatus 101. The ROM 104 stores fixed data, such as control programs to be executed by the CPU 103, a data table, an embedded operating system (hereinafter referred to as OS) program. In the present embodiment, each of the control programs stored in the ROM 104 performs software execution control, such as scheduling, task switching, and interrupt processing, under the control of the embedded OS stored in the ROM 104. The RAM 105 is configured by a static random access memory (SRAM), which needs a backup power supply, and the like. The RAM 105 can store important data, such as program control variables, without volatilization, due to the data being held by a primary battery for data backup (not illustrated). A memory area for storing setting information of the information processing apparatus 101, management data of the information processing apparatus 101, and the like and a program area for deploying a program are also provided in the RAM 105. The RAM 105 is also used as a main memory and a working memory of the CPU 103.

The external storage apparatus 106 stores an application program for executing network setup of the communication apparatus 151 (hereinafter referred to as a setting application), a printing information generation program for generating printing information that can be interpreted by the communication apparatus 151, and the like. The setting application is an application program for setting an access point to be a connection destination of the communication apparatus 151 according to WEC and the like. In addition, the setting application may be provided with another function, other than a network setup function. For example, the setting application may include a function for causing the communication apparatus 151 to perform printing, a function for scanning a document set in the communication apparatus 151, a function for confirming a state of the communication apparatus 151, and the like. The setting application is stored in the external storage apparatus 106 by being installed from an external server, for example, by Internet communication via the communication unit 110. The external storage apparatus 106 stores various programs, such as a transmission and reception control program for transmitting and receiving information to and from the communication apparatus 151 connected via the communication unit 110, and various kinds of information used by these programs.

The output interface 107 is an interface for performing control for displaying data and the state of the information processing apparatus 101 on the display unit 108. The display unit 108 includes a light emitting diode (LED), a liquid crystal display (LCD), and the like and is used for displaying data, presenting the state of the information processing apparatus 101, and the like.

The communication unit 110 connects to apparatuses, such as the communication apparatus 151 and an access point 131, and executes data communication. For example, the communication unit 110 can be connected to an access point (not illustrated) within the communication apparatus 151. By the communication unit 110 and the access point within the communication apparatus 151 being connected, the information processing apparatus 101 and the communication apparatus 151 can communicate with each other. The communication unit 110 may communicate directly with the communication apparatus 151 by wireless communication or may communicate via an external apparatus present outside the information processing apparatus 101 and the communication apparatus 151. The external apparatus includes an external access point (such as the access point 131) present outside the information processing apparatus 101 and outside the communication apparatus 151 and an apparatus capable of relaying communication, other than an access point. In the present embodiment, assume that a wireless communication method used by the communication unit 110 is Wireless Fidelity (Wi-Fi)®, which is a communication standard complying with an IEEE802.11 series. In addition, assume that the above-described WEC is executed by communication by the communication unit 110. The access point 131 includes, for example, a device, such as a wireless LAN router, and the like. In the present embodiment, a method of directly connecting the information processing apparatus 101 and the communication apparatus 151 without passing through an external access point is referred to as a direct connection method. In addition, a method of connecting the information processing apparatus 101 and the communication apparatus 151 via an external access point is referred to as an infrastructure connection method.

The near field wireless communication unit 111 executes data communication by wirelessly connecting to an apparatus, such as the communication apparatus 151, at a short distance and performs communication by a communication method different from that of the communication unit 110. The near field wireless communication unit 111, for example, can be wirelessly connected to a near field wireless communication unit 157 in the communication apparatus 151. Communication methods thereof include, for example, near field communication (NFC), Bluetooth® Classic, Bluetooth Low Energy (BLE), Wi-Fi Aware, and the like.

In the present embodiment, the information processing apparatus 101 executes WEC by the OS of the information processing apparatus 101 based on an instruction for executing network setup processing by the setting application.

Next, the configuration of the communication apparatus 151 will be described.

The communication apparatus 151 is a communication apparatus according to the present disclosure. The communication apparatus 151 includes a ROM 152, a RAM 153, a CPU 154, a print engine 155, a scan engine 162, a communication unit 156, the near field wireless communication unit 157, and the like. A control unit of the communication apparatus 151 is formed by the ROM 152, the RAM 153, the CPU 154, and the like.

The communication unit 156 includes an access point for connecting to an apparatus, such as the information processing apparatus 101, as an access point inside the communication apparatus 151. The access point can be wirelessly connected to the communication unit 110 of the information processing apparatus 101. By the communication unit 156 enabling the access point, the communication apparatus 151 operates as an access point. The communication unit 156 may be wirelessly connected to the information processing apparatus 101, directly or via the access point 131. In the present embodiment, assume that a wireless communication method used by the communication unit 156 is a communication standard complying with the IEEE 802.11 series. Further, in the following descriptions, Wireless Fidelity (Wi-Fi)® (Wi-Fi communication) is a communication standard complying with the IEEE 802.11 series. In addition, if the communication apparatus 151 supports WEC, assume that the above-described WEC is executed by communication by the communication unit 156. The communication unit 156 may include hardware that functions as an access point or may operate as an access point by software for causing the communication unit 156 to function as an access point.

The communication apparatus 151 can operate in an infrastructure mode and a peer to peer (P2P) mode as modes for performing communication using the communication unit 156. The infrastructure mode is a mode in which the communication apparatus 151 communicates with another apparatus, such as the information processing apparatus 101, via an external apparatus (for example, the access point 131) forming a network. A connection with an external access point established by the communication apparatus 151 operating in the infrastructure mode is referred to as an infrastructure connection (hereinafter referred to as an infrastructure connection). In the present embodiment, the communication apparatus 151 operates as a child station and an external access point operates as a parent station in an infrastructure connection. In the present embodiment, the parent station is an apparatus for determining a communication channel to be used in a network to which the parent station belongs, and the child station is an apparatus using the communication channel determined by the parent station without determining a communication channel to be used in the network to which the child station belongs.

The P2P mode is a mode in which the communication apparatus 151 directly communicates with another apparatus, such as the information processing apparatus 101, without passing through an external apparatus forming a network. In the embodiment, assume that the P2P mode includes an AP mode in which the communication apparatus 151 operates as an access point. Assume that connection information (an SSID and a password) of an access point enabled in the communication apparatus 151 in the AP mode can be arbitrarily set by the user. The P2P mode may include, for example, a Wi-Fi Direct (WFD) mode in which the communication apparatus 151 communicates by WFD. Which of a plurality of devices supporting WFD operates as a parent station is determined, for example, in accordance with a sequence of Group Owner Negotiation. A parent station may be determined without executing Group Owner Negotiation. An apparatus that is a device supporting WFD and serves a role of a parent station is specifically referred to as a Group Owner. A direct connection with another apparatus established by the communication apparatus 151 operating in the P2P mode is referred to as a direct connection. In the present embodiment, the communication apparatus 151 operates as a parent station, and another apparatus operates as a child station in the direct connection.

Further, in the embodiment, the communication apparatus 151 can operate in a network setup mode, which is a mode for executing network setup of the communication apparatus 151, by accepting a predetermined operation from the user. When operating in the network setup mode, the communication apparatus 151 operates as an enabled setup access point while operating in the network setup mode, by using the communication unit 156. The setup access point is an access point different from an access point enabled during the above-described AP mode. Further, assume that an SSID of the setup access point includes a predetermined character string that can be recognized by the setting application of the information processing apparatus 101. In addition, assume that the setup access point is an access point that does not require a password for connection.

Assume that the communication apparatus 151 operating in the network setup mode uses a predetermined communication protocol (setup communication protocol) in communication with the information processing apparatus 101 connected to the setup access point. The setup communication protocol specifically is, for example, Simple Network Management Protocol (SNMP). The communication apparatus 151 stops operating in the network setup mode when a predetermined time has elapsed after starting operation in the network setup mode, and disables the setup access point. This is because the setup access point is an access point that does not require a password as described above, and when it is enabled for a long period of time, a possibility that an apparatus that is not supposed to may make a request for connection increases. The setup access point may be an access point that requires a password. In that case, assume that a password to be used for connection with the setup access point is a fixed password (which cannot be changed by the user) known in advance by the setting application.

Further, in the embodiment, the communication apparatus 151 can operate in a mode for executing network setup of the communication apparatus 151 in a communication protocol different from the setup communication protocol. In the embodiment, assume that the communication protocol different from the setup communication protocol is above-described DPP and that a corresponding mode is referred to as a DPP listen mode. When the communication apparatus 151 receives a request for network setup according to DPP from the information processing apparatus 101 while operating in the DPP listen mode, the communication apparatus 151 executes network setup according to DPP. Therefore, the DPP listen mode is, in other words, a mode in which a request for network setup according to DPP is awaited.

The near field wireless communication unit 157 is configured to wirelessly connect with an apparatus, such as the information processing apparatus 101, at a short distance and for example, can be wirelessly connected with the near field wireless communication unit 111 in the information processing apparatus 101. Communication methods thereof include, for example, NFC, Bluetooth Classic, BLE, Wi-Fi Aware, and the like.

The RAM 153 is configured by an SRAM, which needs a backup power supply, and the like. The RAM 153 can store important data, such as program control variables, without volatilization, due to the data being held by a primary battery for data backup (not illustrated). A memory area for storing setting information of the communication apparatus 151, management data of the communication apparatus 151, and the like are also provided in the RAM 153. The RAM 153 also includes a program area of the CPU 154; and is also used as a main memory and a working memory, and stores a reception buffer for temporarily storing print information received from the information processing apparatus 101 and the like, and various kinds of information. The ROM 152 stores fixed data, such as control programs to be executed by the CPU 154, a data table, and an OS program. In the embodiment, each of the control programs and the like stored in the ROM 152 are deployed into the RAM 153, and the CPU 154 performs software execution control, such as scheduling, task switching, and interrupt processing, under the control of an embedded OS by executing the deployed programs. The CPU 154 functions as a system control unit and controls the entire communication apparatus 151.

The print engine 155 forms an image on a printing medium, such as paper, by applying a printing agent, such as ink, to the printing medium based on information stored in the RAM 153 or a print job received from the information processing apparatus 101 or the like, and outputs printed matter. Since amounts of data of print jobs transmitted from the information processing apparatus 101 or the like are generally large, it is necessary to use a communication method capable of high-speed communication for communicating the print jobs. Therefore, the communication apparatus 151 receives a print job via the communication unit 156 capable of performing communication at a higher speed than that of the near field wireless communication unit 157.

The scan engine 162 reads image data or document data from a set document or the like based on input from an operation unit 159 or a scan job received from the information processing apparatus 101 or the like. The read data is stored in the RAM 153 or transmitted to the information processing apparatus 101 or the like as a scan result. Since amounts of data of scan results transmitted from the communication apparatus 151 to the information processing apparatus 101 or the like are generally large, it is necessary to use a communication method capable of high-speed communication for communicating the results. Therefore, the communication apparatus 151 transmits a scanned image via the communication unit 156 capable of performing communication at a higher speed than that of the near field wireless communication unit 157. The communication apparatus 151 may be equipped with a memory, such as an external HDD or an SD card, as an optional device, and information, such as a scan result stored in the communication apparatus 151, may be stored in the memory.

An input interface 158 is an interface for accepting data input and operation instructions from the user by the operation unit 159, such as a physical button, being operated. The operation unit 159 may include a software keyboard and a software button displayed on a display unit 161. That is, the input interface 158 may accept input from the user via the display unit 161. An output interface 160 is an interface for performing control for the display unit 161 to display data and present the state of the communication apparatus 151. The display unit 161 includes a light emitting diode (LED), a liquid crystal display (LCD), and the like and performs display of data, presentation of the state of the communication apparatus 151, and the like.

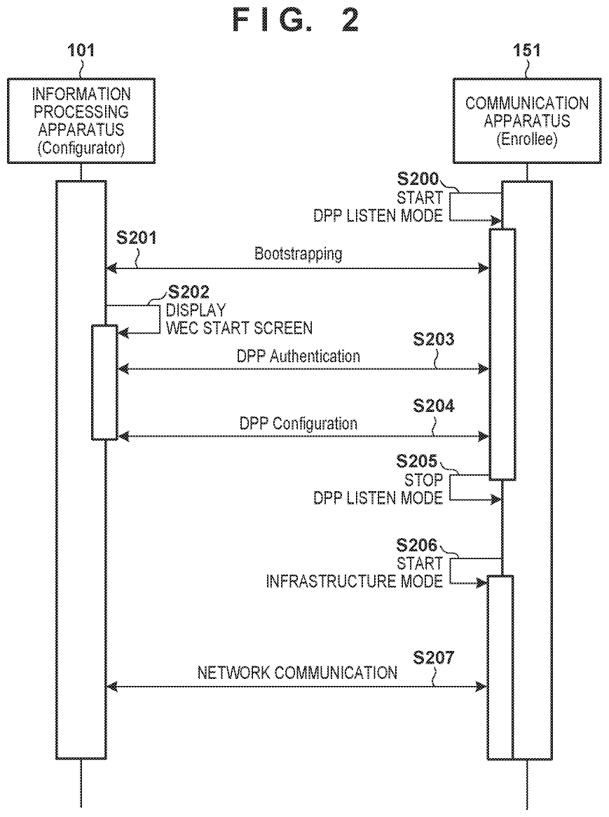

FIG. 2 is a sequence diagram for describing communication processing executed by the information processing apparatus 101 and the communication apparatus 151 according to the embodiment using WEC in which DPP is used. The processing illustrated in FIG. 2 is realized, for example, by a CPU of each of the apparatuses executing a program stored in a ROM, an external storage apparatus, or the like of that apparatus by deploying the program in a RAM of that apparatus.

First, in step 5200, the communication apparatus 151 starts the DPP listen mode. A trigger for starting the DPP listen mode may be, for example, a user operation via the operation unit 159 or may be reception of a specific signal from an external apparatus, such as the information processing apparatus 101. Details of the processing for starting the DPP listen mode will be described later with reference to FIG. 4.

When the DPP listen mode is started, reading of WEC-related information becomes possible. For example, when a two-dimensional bar code, such as a QR code®, is used in bootstrapping illustrated in step S201, the communication apparatus 151 generates a two-dimensional bar code based on WEC-related information and displays the two-dimensional bar code on the display unit 161. In step S201, the information processing apparatus 101 obtains WEC-related information by bootstrapping. For example, when a two-dimensional bar code is used for bootstrapping, the information processing apparatus 101 executes a two-dimensional bar code imaging function in the setting application. In the two-dimensional bar code imaging function, an image of a two-dimensional bar code is captured using an imaging unit 112 and the two-dimensional bar code is analyzed based on the captured image. This makes it possible for the setting application to obtain WEC-related information, such as identification information and a public key of the communication apparatus 151, for example, included in a two-dimensional bar code.

In step S202, the information processing apparatus 101 starts WEC in which DPP is used, by a function of the OS. Specifically, the information processing apparatus 101 first starts a WEC application by giving an instruction for starting a WEC application from the setting application to the OS. Thus, the WEC application operates in the foreground and the setting application operates in the background. For example, execution of this start instruction corresponds to an instruction for executing WEC.

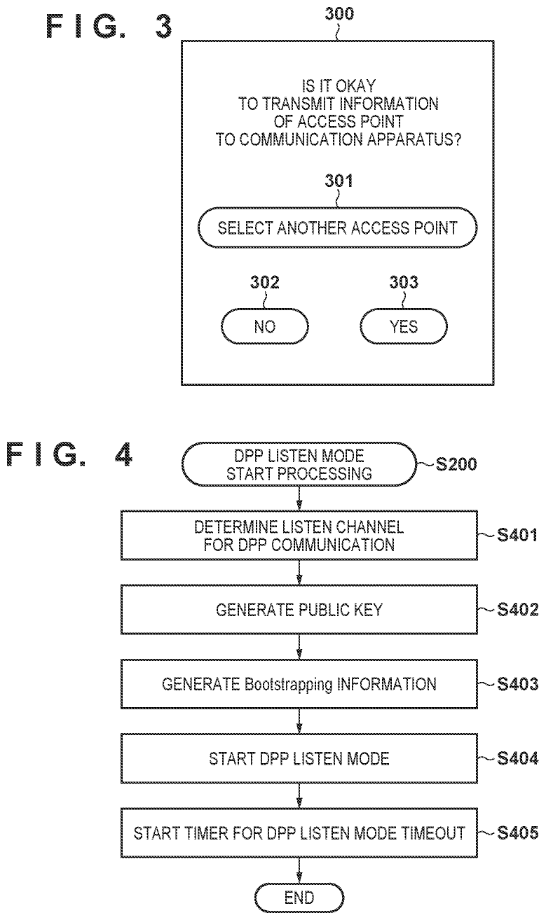

Thus, the information processing apparatus 101 displays a WEC start screen (FIG. 3) by the WEC application. The WEC application is a program installed in advance in the information processing apparatus 101 and is a program provided by an OS vendor of the information processing apparatus 101. When the WEC application is started, WEC-related information obtained by the setting application is provided to the WEC application.

FIG. 3 is a diagram illustrating an example of a WEC start screen displayed by the information processing apparatus 101 according to the embodiment via the WEC application.

A WEC start window 300 displays buttons 301, 302, and 303. The button 301 is a “select another access point” button and is a button for instructing a change of an access point set as a target of setting according to WEC. An access point set as the target of setting according to WEC before the button 301 is operated is an access point to which the information processing apparatus 101 is currently connected. When the button 301 is selected, the information processing apparatus 101 displays a list of access points and newly sets an access point selected by the user from the list as the target of setting according to WEC. Assume that the list of access points includes access points and the like to which the information processing apparatus 101 has been connected.

The “no” button 302 is a button for canceling execution of WEC, and the “yes” button 303 is a button for instructing execution of WEC. When the “no” button 302 is operated, the information processing apparatus 101 ends the processing illustrated in the sequence diagram of FIG. 2. When the “yes” button 303 is pressed, the information processing apparatus 101 proceeds to step S203.

In step S203, the WEC application instructs the OS to execute WEC by executing a WEC API using the WEC-related information and information related to the access point set as the target of setting according to WEC. Then, authentication processing called DPP Authentication is executed between the information processing apparatus 101 and the communication apparatus 151 by a function of the OS. In DPP Authentication, communication between the information processing apparatus 101 and the communication apparatus 151 is authenticated by authentication information, information used for encrypting information, and the like being communicated between the apparatuses. Various kinds of information transmitted from the information processing apparatus 101 in communication in DPP Authentication are encrypted based on the WEC-related information obtained from the communication apparatus 151 by the information processing apparatus 101. In DPP Authentication, specifically, the information processing apparatus 101 first transmits an Authentication Request as a request for network setup according to DPP. At this time, the communication apparatus 151 operating in the DPP listen mode operates in the DPP listen mode, which is a mode in which an Authentication Request is awaited. Therefore, when an Authentication Request transmitted from the information processing apparatus 101 is received, the communication apparatus 151 attempts to decrypt the received Authentication Request by a currently-held decryption key. When the decryption is successful, the communication apparatus 151 authenticates communication with the information processing apparatus 101 by transmitting an Authentication Response to the information processing apparatus 101. When the information processing apparatus 101 has not accurately encrypted information due to not having obtained accurate WEC-related information, decryption in the communication apparatus 151 fails. In this case, the authentication fails and no Authentication Response is transmitted from the communication apparatus 151 to the information processing apparatus 101. DPP Authentication is completed by an Authentication Response being received by the information processing apparatus 101. In DPP Authentication, communication is performed using DPP.

Next, in step S204, processing called DPP Configuration is executed between the information processing apparatus 101 and the communication apparatus 151 by a function of the OS. In DPP Configuration, the information processing apparatus 101 transmits connection information for connecting with an access point set as a target of setting according to WEC to the communication apparatus 151 according to WEC. The connection information includes at least one piece of information and the like indicating an SSID, a password, and an encryption method of the access point set as the target of setting according to WEC. The password transmitted at this time is information inputted by the user on a screen displayed by an OS compatible application when a connection between the information processing apparatus 101 and the access point is established. The password is information held by the OS when the connection between the information processing apparatus 101 and the access point has been established. Also, the password is information not held by the setting application. Since the password to be transmitted at this time is information already held by the OS and DPP Configuration is processing executed by the OS, there is no need to for the user to newly input the password on a screen displayed by the setting application.

By transmitting connection information according to WEC as in the embodiment, a password can be transmitted to the communication apparatus 151 without newly receiving input of a password from the user on a screen displayed by the setting application and in secure communication. Also in DPP Configuration, communication is performed using DPP.

Next, in step S205, the communication apparatus 151 ends the DPP listen mode in response to completion of DPP Configuration. In step S206, the communication apparatus 151 transitions to the infrastructure mode after connection information has been obtained by DPP Configuration. The communication apparatus 151 then attempts to connect to the access point (such as the access point 131) corresponding to the connection information using the connection information. When the connection is successful, the communication apparatus 151 thereafter can execute communication via a network formed by the connected access point. Here, the communication via the network formed by the connected access point is executed by a protocol (specifically, such as Port 9100, SNMP, or a protocol specific to a vendor of the communication apparatus 151) different from DPP.

At this time, the communication apparatus 151 may transmit information indicating a success or failure of connection with the access point corresponding to the connection information obtained according to WEC to the information processing apparatus 101. Further, when connection with the access point corresponding to the connection information obtained according to WEC fails, the communication apparatus 151 may transmit information indicating a cause of the failure to the information processing apparatus 101. DPP may also be used to transmit these kinds of information. The cause of failure in the connection with the access point corresponding to the connection information obtained according to WEC is conceivably a communication error in WEC, an access point not being found, the WEC-related information obtained from the communication apparatus 151 not being appropriate information, or the like. For example, it is also conceivable that an encryption method used for connecting with the access point set as the target of setting according to WEC is an encryption method not supported by the communication apparatus 151. For example, it is also conceivable that an encryption method used for connecting with the access point set as the target of setting according to WEC is an encryption method not supported by WEC.

At this time, the information processing apparatus 101 may display information indicating a success or failure of connection between the access point corresponding to the connection information obtained according to WEC and the communication apparatus 151 on the display unit 108. Further, when the connection between the access point corresponding to the connection information obtained according to WEC and the communication apparatus 151 fails, information indicating a cause of failure may be displayed on the display unit 108.

Then, in step 5207, the information processing apparatus 101 switches the application operating in the foreground from the WEC application to the setting application based on the execution of WEC having ended. The information processing apparatus 101 then searches for the communication apparatus 151 on a network to which the information processing apparatus 101 belongs. This processing is executed by the setting application that received a notification from the OS that the execution of WEC has ended. When the communication apparatus 151 is found, the information processing apparatus 101 makes a request to the communication apparatus 151 for capability information of the communication apparatus 151, and the communication apparatus 151 transmits the capability information to the information processing apparatus 101. The information processing apparatus 101 thus registers information of the communication apparatus 151 on the setting application. Thus, from this point on, communication with the communication apparatus 151 can be executed by the setting application. Specifically, for example, it becomes possible for the information processing apparatus 101 to transmit a print job to the communication apparatus 151 by the setting application.

At this time, when the information processing apparatus 101 belongs to the network formed by the access point connected to the communication apparatus 151 according to WEC, communication with the communication apparatus 151 can be performed via the access point. When communication between the information processing apparatus 101 and the communication apparatus 151 cannot be performed, such as when the access point to which the communication apparatus 151 is connected is not an access point to which the information processing apparatus 101 is connected, requesting and obtainment of the capability information are omitted. The network communication in step S207, for example, is performed using a communication protocol different from the setup communication protocol, such as DPP or SNMP. When the network communication is ended, the information processing apparatus 101 ends the processing.

In the above description, a form in which a WEC start screen is displayed by the WEC application and WEC execution is instructed to the OS by the WEC application executing the WEC API has been described; however, the present invention is not limited to this form. For example, the WEC start screen may be displayed by the setting application. Further, a form may be taken so as to instruct execution of WEC to the OS by the setting application executing the WEC API.

FIG. 4 is a flowchart for explaining DPP listen mode start processing performed by the communication apparatus 151 according to the embodiment in step S200 of FIG. 2. The processing described in this flowchart is realized by, for example, the CPU 154 executing a setting application stored in the ROM 152, the memory, or the like by deploying the setting application in the RAM 153. The processing described in the flowchart of FIG. 4, for example, is started based on the communication apparatus 151 having started the network setup mode.

In step S401, the CPU 154 determines a listen channel for DPP communication. The listen channel for DPP communication is a channel for listening (waiting) for a request for network setup according to DPP transmitted from the information processing apparatus 101. The same channel is used in DPP Configuration processing. Which channel to use for the listen channel for DPP communication, for example, may be set by the user from the operation unit 159 of the communication apparatus 151.

Next, the processing proceeds to step S402, and the CPU 154 generates public key information used for secure communication with the information processing apparatus 101. Next, the processing proceeds to step S403, and the CPU 154 generates bootstrapping information including identification information (e.g., a MAC address) of the communication apparatus 151, information related to the listen channel for DPP communication, public key information generated in step S402, and the like. Then, the processing proceeds to step S404, and the CPU 154 starts the DPP listen mode. When the DPP listen mode is started, communication in DPP Authentication can be performed between the communication apparatus 151 and the information processing apparatus 101.

Next, the processing proceeds to step S405, and the CPU 154 starts a timer for DPP listen mode timeout. When a predetermined time has elapsed after the CPU 154 started operation in the DPP listen mode, a value counted by the timer for DPP listen mode timeout exceeds a threshold, and the DPP listen mode timeout occurs, the CPU 154 ends the DPP listen mode.

Before executing step S401 of FIG. 4, the CPU 154 may determine whether the communication apparatus 151 has started the network setup mode. A configuration may be taken such that when the communication apparatus 151 has started the network setup mode, the CPU 154 causes the processing to proceed to step S401, and when the communication apparatus 151 has not started the network setup mode, the CPU 154 ends the processing illustrated in this flowchart without starting the DPP listen mode.

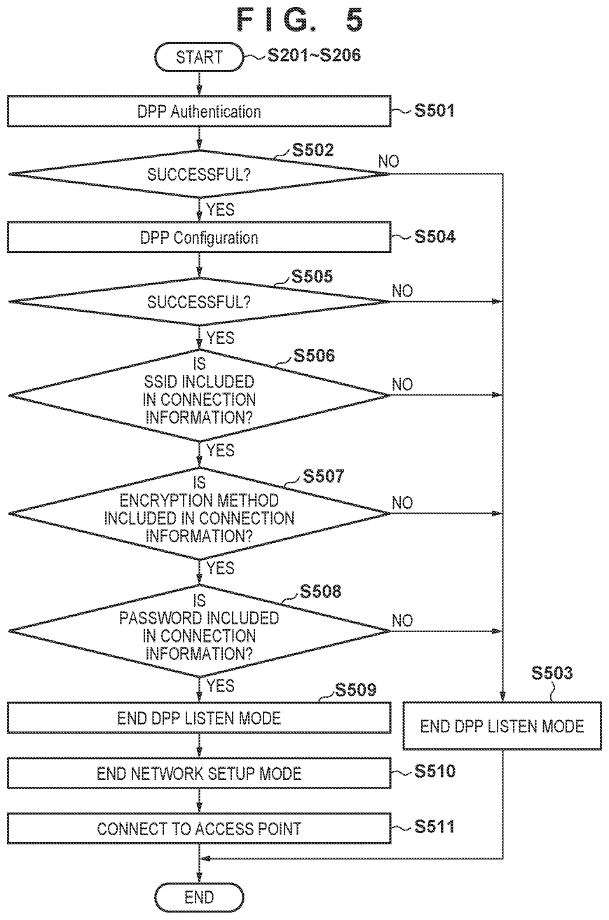

FIG. 5 is a flowchart for explaining WEC execution processing executed by the communication apparatus 151 according to the embodiment from step S203 to step S206 of FIG. 2. The processing described in the flowchart of FIG. 5 is realized by, for example, the CPU 154 executing the setting application stored in the ROM 152, the memory, or the like by deploying the setting application in the RAM 153. The processing illustrated in the flowchart of FIG. 5 is started based on the communication apparatus 151 receiving a DPP Authentication request from the information processing apparatus 101.

In step S501, the CPU 154 performs DPP Authentication processing. As describe above, in DPP Authentication processing, communication between the information processing apparatus 101 and the communication apparatus 151 is authenticated by authentication information, information used for encrypting information, and the like being communicated between the apparatuses. Next, the processing proceeds to step S502, and the CPU 154 determines whether DPP Authentication processing with the information processing apparatus 101 is successful. As described above, various kinds of information transmitted from the information processing apparatus 101 in the communication for DPP Authentication processing are transmitted after being encrypted in the information processing apparatus 101. When the CPU 154 successfully decrypts the information received from the information processing apparatus 101 using a decryption key held in advance, the CPU 154 authenticates communication with the information processing apparatus 101. When the information processing apparatus 101 has not accurately encrypted information due to not having obtained accurate WEC-related information, decryption in the communication apparatus 151 fails, and so the authentication fails. When authentication of communication with the information processing apparatus 101 is successful, the CPU 154 determines that DPP Authentication processing is successful and the processing proceeds to step S504. Meanwhile, when decryption fails, the CPU 154 determines that authentication has failed in the DPP Authentication processing, the processing proceeds to step S503, the CPU 154 ends the DPP listen mode, and ends the processing.

When it is determined in step S502 that authentication is successful, in step S504, the CPU 154 executes DPP Configuration processing. In the DPP Configuration processing, the CPU 154 receives connection information for connecting with an access point set as a target of setting according to WEC from the information processing apparatus 101 according to WEC. The connection information includes information and the like indicating an SSID and a password of the access point set as the target setting according to WEC and an encryption method. Next, the processing proceeds to step S505, and the CPU 154 determines whether DPP Configuration processing with the information processing apparatus 101 is successful. Specifically, when the connection information for connecting with an access point set as a target of setting according to WEC from the information processing apparatus 101 is received according to WEC, the CPU 154 determines that the processing is successful, and when the connection information is not received, the CPU 154 determines that the processing has failed. When it is determined in step S505 that the DPP Configuration processing has failed, the processing proceeds to step S503, the CPU 154 ends the DPP listen mode, and ends the processing. Meanwhile, when it is determined in step S505 that the DPP Configuration processing is successful, the processing proceeds to step S506. When the processing thus proceeds to step S506, it means the CPU 154 has obtained an SSID, an encryption method, and a password of the access point.

In step S506, the CPU 154 determines whether an SSID is included in the connection information received from the information processing apparatus 101. When it is determined in step S506 that an SSID is not included, the processing proceeds to step S503, the CPU 154 ends the DPP listen mode, and ends the processing. Meanwhile, when it is determined in step S506 that an SSID is included, the processing proceeds to step S507. In step S507, the CPU 154 determines whether an encryption method is included in the connection information received from the information processing apparatus 101. When it is determined that an encryption method is not included, the processing proceeds to step S503, and when it is determined in step S507 that an encryption method is included, the processing proceeds to step S508. In step S508, the CPU 154 determines whether a password is included in the connection information received from the information processing apparatus 101. When connecting to the access point using DPP communication at this time, the CPU 154 may determine whether public key information is included instead of a password. Also, when a security setting of the access point set as the setting target is set to be disabled, a password need not be included. When it is determined in step S508 that a password is not included, the processing proceeds to step S503, the CPU 154 ends the DPP listen mode, and ends the processing. When it is determined in step S508 that a password is included, the processing proceeds to step S509, the CPU 154 ends the DPP listen mode, and the processing proceeds to step S510. When the CPU 154 ends the DPP listen mode, the CPU 154 cannot respond to a request for DPP Authentication processing from the information processing apparatus 101.

In step S510, the CPU 154 ends the network setup mode and disables the setup access point. Either the operation in the network setup mode in step S510 or the operation in the DPP listen mode in step S509 may be ended first. That is, the CPU 154 may end the operation in the DPP listen mode after ending the operation in the network setup mode. The operation in the network setup mode and operation in DPP listen mode may be ended simultaneously. Moreover, the order of processing for ending operation in the network setup mode or processing for ending operation in the DPP listen mode, and processing for connecting with an access point does not matter.

Next, the processing proceeds to step S511, and the CPU 154 connects to a corresponding access point based on various kinds of information (an SSID, a password, and an encryption method) of the access point set as the target of setting according to WEC, received from the information processing apparatus 101. The CPU 154 then ends this flowchart.

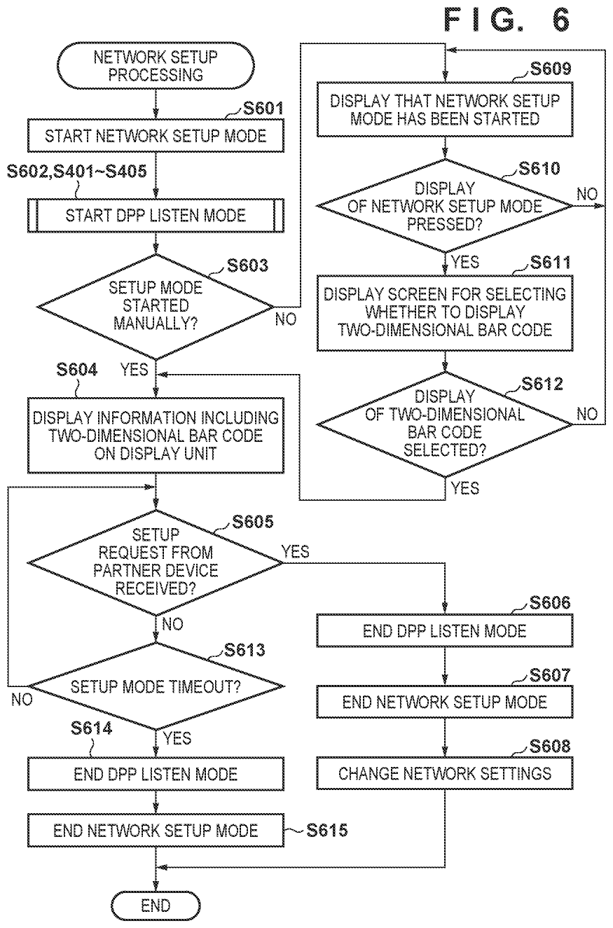

FIG. 6 is a flowchart for explaining network setup processing in the communication apparatus 151 according to the embodiment. The processing described in this flowchart is started based on an operation, such as, the user turning on the power of the communication apparatus 151, the user initializing network settings of the communication apparatus 151, or the user starting the network setup mode from the operation unit 159 of the communication apparatus 151, for example. The processing described in the flowchart of FIG. 6 is realized by, for example, the CPU 154 executing the setting application stored in the ROM 152, the memory, or the like by deploying the setting application in the RAM 153.

In step S601, the CPU 154 starts operation in the network setup mode, which is a mode for performing network setup. Then, in step S602, the CPU 154 starts the DPP listen mode. The processing of step S602 corresponds to the processing from step S401 to step S405 of FIG. 4.

Next, the processing proceeds to step S603, and the CPU 154 determines whether the network setup mode has been started manually. Here, an operation determined to have been started manually, for example, is when the user starts the network setup mode directly from the operation unit 159 of the communication apparatus 151. In contrast, the network setup mode that is started when the user has turned on the power of the communication apparatus 151 or the user has initialized the network settings of the communication apparatus 151 is determined to have been started automatically. When it is determined in step S603 that the network setup mode has been manually started, the processing proceeds to step S604 and the CPU 154 displays information including a two-dimensional bar code on the display unit 161. Here, a two-dimensional bar code includes, for example, bootstrapping information for executing network setting according to WEC. The bootstrapping information includes, for example, identification information (such as a MAC address) of an Enrollee apparatus (here, the communication apparatus 151), public key information used for performing secure communication with the Enrollee apparatus, and the like.

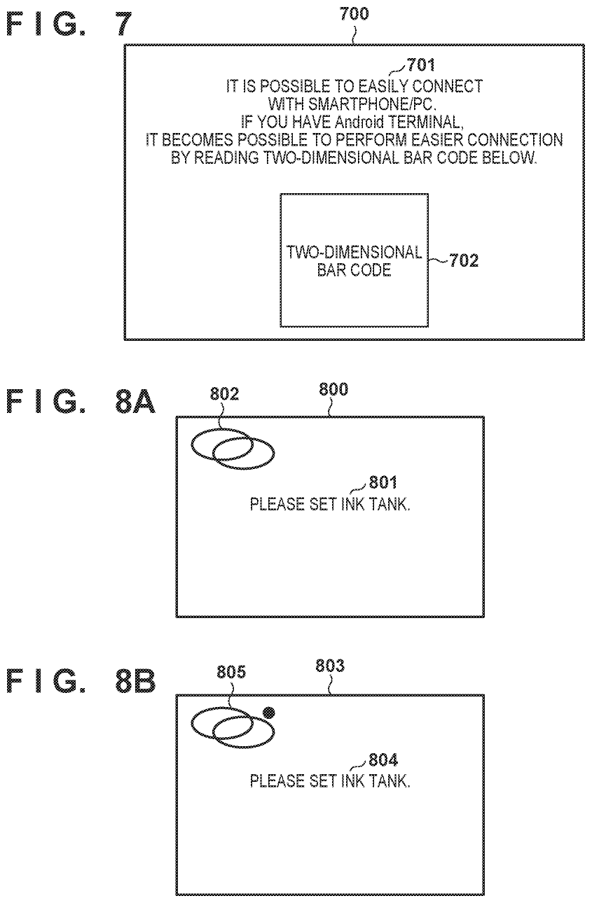

FIG. 7 is a diagram illustrating an example of a screen displayed on the display unit 161 in step S604 of FIG. 6.

A screen 700 displays regions 701, 702. The region 701 displays an example of descriptive text of a procedure for performing network setup. The region 702 displays bootstrapping information for performing the above-described network setting using a two-dimensional bar code. The information processing apparatus 101 can obtain WEC-related information by capturing an image of the two-dimensional bar code in the region 702 using the imaging unit 112 in the setting application and analyzing the two-dimensional bar code from the captured image. This makes it possible to make a request for DPP Authentication processing from the information processing apparatus 101 to the communication apparatus 151.

Next, the processing proceeds to step S605, and the CPU 154 determines whether a request for network setup has been received from the information processing apparatus 101. Here, the request for network setup need not only be a request for setup according to WEC in which DPP is used but may also be a request for setup by a setup method other than WEC. For example, when a request for network setup according to WEC is received, the processing corresponding to that from step S501 to step S508 of FIG. 5 has been executed by the time of step S605. Therefore, it means that at this point the communication apparatus 151 has received the connection information of the access point with which the communication apparatus 151 is to be connected from the information processing apparatus 101. When it is determined in step S605 that a request for network setup has been received, the processing proceeds to step S606 and the CPU 154 ends the DPP listen mode. When the CPU 154 ends the DPP listen mode, the CPU 154 cannot respond to a request for DPP Authentication processing from the information processing apparatus 101. Then, the processing proceeds to step S607, and the CPU 154 ends the network setup mode and disables the setup access point. Either the operation in the network setup mode in step S607 or the operation in the DPP listen mode in step S606 may be ended first. That is, the CPU 154 may end the operation in the DPP listen mode after ending the operation in the network setup mode. The operation in the network setup mode and operation in DPP listen mode may be ended simultaneously. Moreover, the order of processing for ending operation in the network setup mode or processing for ending operation in the DPP listen mode, and processing for connecting with an access point does not matter.

Then, the processing proceeds to step S608, and the CPU 154 connects to a corresponding access point based on various kinds of information (an SSID, a password, and an encryption method) of the access point received from the information processing apparatus 101 and ends the processing.

Meanwhile, when the CPU 154 does not determine in step S603 that the mode has been started manually, the processing proceeds to step S609 and the CPU 154 displays on the display unit 161 that the network setup mode has been started. Here, the display that the network setup mode has been started is indicated in a partial region of the display unit 161 in order to allow the user to perform an operation other than network setup.

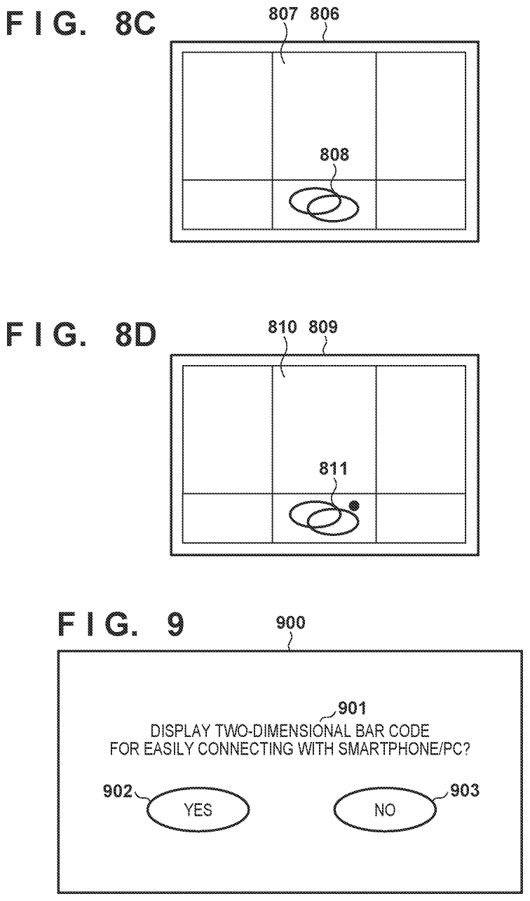

FIGS. 8A to 8D illustrate diagrams of examples of screens displaying that the network setup mode has been started in step S609 of FIG. 6.

FIG. 8A illustrates an example of an arrival processing screen that is displayed on the display unit 161 when the power of the communication apparatus 151 is turned on for the first time. In FIG. 8A, a touch panel is assumed as the display unit 161. A region 801 and an icon 802 are displayed on a screen 800. The region 801 displays text for explaining a necessary procedure to the user at the time of arrival. The icon 802 indicates an icon indicating whether the network setup mode has been started. The icon 802, for example, indicates an icon in a state in which the network setup mode has not been started.

FIG. 8B illustrates an example of an arrival processing screen that is displayed on the display unit 161 when the power of the communication apparatus 151 is turned on for the first time. In FIG. 8B, a touch panel is assumed as the display unit 161. A region 804 and an icon 805 are displayed on a display screen 803. The region 804 displays text for explaining a necessary procedure to the user at the time of arrival, similarly to the region 801 of FIG. 8A. The icon 805 is an icon indicating whether the network setup mode has been started, similarly to the icon 802 of FIG. 8A. The icon 805 indicates an icon in a state in which the network setup mode has been started.

FIG. 8C illustrates an example of a screen that is displayed on the display unit 161 when the power of the communication apparatus 151 is turned on in a state in which the arrival processing is complete. In FIG. 8C, a touch panel is assumed as the display unit 161. A region 807 and an icon 808 are displayed on a display screen 806. The region 807 may display, for example, an icon for performing copying, printing, or scanning; an icon for displaying a setting screen; or an icon for performing another operation. The icon 808 indicates an icon indicating whether the network setup mode has been started. The icon 808, for example, indicates an icon in a state in which the network setup mode has not been started.

FIG. 8D illustrates an example of a screen that is displayed on the display unit 161 when the power of the communication apparatus 151 is turned on in a state in which the arrival processing is complete. In FIG. 8D, a touch panel is assumed as the display unit 161. A region 810 and an icon 811 are displayed on a display screen 809. The region 810 may display, for example, an icon for performing copying, printing, or scanning; an icon for displaying a setting screen; or an icon for performing another operation, similarly to the region 807 of FIG. 8C. The icon 811 is an icon indicating whether the network setup mode has been started, similarly to the icon 808 of FIG. 8C. The icon 811 indicates an icon in a state in which the network setup mode has been started.

A display thus indicating that the network setup mode has been started is indicated in a partial region of the display unit 161 in order to allow a user operation other than that for network setup. In the present embodiment, a state of whether the network setup mode has been started is expressed by an icon on the touch panel but may be expressed by turning off, turning on, blinking, or the like of an LED.

Next, the processing proceeds to step S610, and the CPU 154 determines whether the user has performed an instruction operation of a display of the network setup mode. An instruction operation of a display of the network setup mode is, for example, a pressing operation of the above-described icon 805 of FIG. 8B or icon 811 of FIG. 8D. When it is determined in step S610 that the icon has not been pressed, the processing returns to step S609. Meanwhile, when it is determined in step S610 that the icon has been pressed, the processing proceeds to step S611. In step S611, the CPU 154 displays a screen for selecting whether to display a two-dimensional bar code on the display unit 161. Here, an example in which the display unit 161 is a touch panel, and an instruction of the display of the network setup mode is performed by a press of the icon 805 of FIG. 8B or the icon 811 of FIG. 8D has been described. However, the present invention is not limited to this, and for example, the user is prompted to recognize that the network setup mode has been started by the display of the icon 805 of FIG. 8B or the icon 811 of FIG. 8D. As for the instruction operation of the display of the network setup mode, the instruction operation of the display of the network setup mode may be performed by a press of a separately-provided physical button.

FIG. 9 is a diagram illustrating an example of a selection screen displayed on the display unit 161 of the communication apparatus 151 in step S611 of FIG. 6.

A selection screen 900 includes a region 901, a button 902, and a button 903. The region 901 displays text asking the user whether to display a two-dimensional bar code. The “yes” button 902 is a button for instructing a display of a two-dimensional bar code, and the “no” button 903 is a button for cancelling display of a two-dimensional bar code. Next, the processing proceeds to step S612, and the CPU 154 determines whether the user has selected the “yes” button 902. When it is it is determined that the user has pressed the above-described “yes” button 902 in FIG. 9, the processing proceeds to step S604, and when it is determined that the user has pressed the “no” button 903, the processing returns to step S609. Here, a configuration in which the display unit 161 is a touch panel and the “yes” button 902 and the “no” button 903 are displayed on the display unit 161 has been described. However, the present invention is not limited to this, and a configuration may be taken so as to display only the text asking the user whether to display a two-dimensional bar code on the display unit 161 and the “yes” button and the “no” button are provided as physical buttons.

In the present embodiment, when the user presses the icon instructing the display of the network setup mode in step S610, a screen for asking whether to display a two-dimensional bar code is displayed on the display unit 161 in step S611. Then, when the user selects the “yes” button 902, a two-dimensional bar code is displayed in step S604. However, a configuration may be taken such that when the display of the network setup mode is pressed in step S610, the processing proceeds to step S604 without displaying the selection screen 900 for confirming whether to display a two-dimensional bar code, and a two-dimensional bar code is displayed.

Also, in step S605, when a request for network setup has not been received from a partner device (here, the information processing apparatus 101), the processing proceeds to step S613. In step S613, the CPU 154 determines whether a time that has elapsed since the network setup mode has been started has exceeded a predetermined time. In step S613, when it is determined that the predetermined time has not elapsed, the processing proceeds to step S605. Meanwhile, in step S613, when it is determined that the predetermined time has elapsed, the processing proceeds to step S614. In step S614, the CPU 154 ends the DPP listen mode, and in step S615, the CPU 154 ends the network setup mode. The processing of step S614 is the same as the processing of step S606. The processing of step S615 is the same as the processing of step S607.

As described above, according to the embodiment, when the network setup mode operation of the communication apparatus 151 is automatically started, a display indicating that the network setup mode has been started is performed. Here, a display indicating that the network setup mode has been started is indicated in one part of a screen of the display unit 161 in order to allow a user operation other than that for network setup. Then, depending on the user's selection, a screen for confirming whether to display a two-dimensional bar code for executing network setup according to WEC in which DPP is used is displayed. This makes it possible to notify the user that network setup is possible even when the user is not aware network setup is possible. In addition, since a user operation other than that for network setup is also possible, the usability is improved.

When the user manually starts the network setup mode operation of the communication apparatus 151, the user intends to perform network setup, and so, a two-dimensional bar code may be displayed on the display unit 161 from the beginning.

Thus, when it is possible to establish connection between the predetermined access point and the communication apparatus 151 according to WEC, simple setup in which password input by the user or the like is omitted can be realized by performing setup according to WEC. In addition, when it is not possible to establish connection between the predetermined access point and the communication apparatus 151 according to WEC, it becomes possible to more reliably establish the connection between the access point and the communication apparatus 151 by performing setup by a function different from WEC.

In addition, in the present embodiment, when the communication apparatus 151 can be connected to a predetermined access point to be set, the information processing apparatus 101 is controlled so as to transmit connection information of the predetermined access point to the communication apparatus 151 according to WEC. Further, when the communication apparatus 151 cannot be connected to a predetermined access point, the information processing apparatus 101 is controlled so as to transmit connection information of an access point different from the predetermined access point to the communication apparatus 151 by network setup in which a setup protocol is used. A case where the communication apparatus 151 can be connected to a predetermined access point, for example, is a case where the communication apparatus 151 supports an encryption method used for connecting with a predetermined access point. It is also a case where the communication apparatus 151 supports a frequency band used for connecting with a predetermined access point. A case where the communication apparatus 151 cannot be connected to a predetermined access point, for example, is a case where the communication apparatus 151 does not support an encryption method used for connecting with a predetermined access point. It is also a case where the communication apparatus 151 does not support a frequency band used for connecting with a predetermined access point. In the present embodiment, even when the communication apparatus 151 can be connected to a predetermined access point, when WEC does not support the encryption method, the information processing apparatus 101 is controlled so as to transmit connection information of an access point different from the predetermined access point to the communication apparatus 151.

The input for permitting the execution of setting related to wireless connection of the communication apparatus 151 may be performed by a physical button or the like outside the screen. The input for permitting the execution of setting related to wireless connection of the communication apparatus 151 may also be performed by voice via a voice output unit (not illustrated) instead of a screen display.

Further, in the embodiment, the DPP listen mode is started after the network setup mode is started; however, the present invention is not limited to this method. For example, the network setup mode may be started after the DPP listen mode is started. That is, when a condition for starting the network setup mode and a condition for starting the DPP listen mode are the same, the two modes may be started at the same time regardless of the start order. Also, either the network setup mode or the DPP listen mode may be started on a condition that the other has been started.

In the embodiment, the communication apparatus 151 ends the DPP listen mode when WEC execution fails; however, the communication apparatus 151 may not end the DPP listen mode. This makes it possible to execute the network setup again in response to a request for executing the network setup or a request for executing WEC from the information processing apparatus.

Further, in the embodiment, when either a request for executing network setup or a request for executing WEC is received, the communication apparatus 151 maintains enabling of a mode related to a request for executing the other. In other words, even when a request for executing network setup is received, the DPP listen mode remains enabled. However, when either a request for executing network setup or a request for executing WEC is received, the communication apparatus 151 may disable a mode related to a request for executing the other. For example, when a request for executing WEC is received, the network setup mode may be ended. Thus, when either a request for executing network setup or a request for executing WEC is received, by disabling a mode related to a request for executing the other, it becomes possible to prevent unintended execution of network setup.

When WEC execution fails when a request for executing WEC is received and the network setup mode is ended, the network setup mode is restarted based on a failure of WEC execution. This makes it possible to execute network setup again in response to a request for executing network setup from the information processing apparatus.

### Other Embodiments

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure includes exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-077179, filed May 9, 2022, which is hereby incorporated by reference herein in its entirety.

What is claimed is:

1. A communication apparatus operable to communicate with an information processing apparatus, the communication apparatus comprising:
one or more memories storing instructions; and
one or more processors that execute the instructions to:
present information necessary for wireless setting to a user based on a condition for having entered a state in which the wireless setting for performing wireless communication with the information processing apparatus is able to be started being a first condition,
display a screen including information indicating that the wireless setting is able to be started, based on the condition for having entered the state in which the wireless setting is able to be started being a second condition different from the first condition, and in response to an instruction of the user via the screen, present the information necessary for the wireless setting to the user,
receive a request for the wireless setting from the information processing apparatus that has obtained connection information based on the information presented based on the condition being the first condition or the information presented in response to the instruction of the user via the screen, and
execute the wireless setting in response to the received request.

2. The communication apparatus according to claim 1, wherein the first condition is a case where the state in which the wireless setting is able to be started is caused manually by the user.

3. The communication apparatus according to claim 1, wherein the second condition is a case where the state in which the wireless setting is able to be started is caused automatically by the communication apparatus.

4. The communication apparatus according to claim 2, wherein the second condition is caused by turning on of a power of the communication apparatus.

5. The communication apparatus according to claim 2, wherein the second condition is caused by initialization of the communication apparatus.

6. The communication apparatus according to claim 1, wherein the request to be received includes information of an access point to be used in the wireless communication with the information processing apparatus.

7. The communication apparatus according to claim 1, wherein the information necessary for the wireless setting is displayed in a two-dimensional bar code.

8. The communication apparatus according to claim 7, wherein the one or more processors further execute the instructions to: in response to the instruction of the user via the screen, prompt the user to select whether to display the two-dimensional bar code.

9. The communication apparatus according to claim 1, wherein the information necessary for the wireless setting includes identification information and public key information of the communication apparatus.

10. The communication apparatus according to claim 1, wherein the information indicating that the wireless setting is able to be started, displayed on the screen includes an icon indicating whether the wireless setting is able to be started.

11. The communication apparatus according to claim 10, wherein the instruction of the user via the screen is a user operation with respect to the icon by the user.

12. The communication apparatus according to claim 1, wherein the connection information is connection information for connecting with an access point.

13. The communication apparatus according to claim 12, wherein in the wireless setting, an infrastructure mode in which the access point is passed through is set.

14. The communication apparatus according to claim 1, wherein the information processing apparatus supports a Wi-Fi Easy Connect (WEC) function, and the wireless setting is executed using Device Provisioning Protocol (DPP).

15. A communication system including an information processing apparatus and a communication apparatus,
the communication apparatus comprising:
one or more first memories storing instructions; and
one or more first processors that execute the instructions to:
present information necessary for wireless setting to a user based on a condition for entering a state in which the wireless setting for performing wireless communication with the information processing apparatus is able to be started being a first condition,
display a screen including information indicating that the wireless setting is able to be started, based on the condition for entering the state in which the wireless setting can be started being a second condition different from the first condition, and in response to an instruction of the user, present the information necessary for the wireless setting to the user via the screen,
receive a request for the wireless setting from the information processing apparatus that has obtained connection information based on the information presented based on the condition being the first condition or the information presented in response to the instruction of the user via the screen, and
execute the wireless setting in response to the received request,
the information processing apparatus, comprising:
one or more second memories storing instructions; and
one or more second processors that execute the instructions to:
obtain the information necessary for the wireless setting by capturing an image of the information presented based on the condition being the first condition or the information presented in response to the instruction of the user via the screen, and
obtain the connection information based on the obtained information and information of an access point to be set, and transmit as the request for the wireless setting the connection information to the communication apparatus.

16. The communication system according to claim 15, wherein the one or more second processors further execute the instructions to: select the access point to be set.

17. The communication system according to claim 15, wherein the one or more second processors further execute the instructions to: authenticate the communication apparatus using the information necessary for the wireless setting, and in the transmission of the request for the wireless setting, transmits the request for the wireless setting to the communication apparatus in response to a success of the authentication.

18. The communication system according to claim 17, wherein the success of the authentication of the communication apparatus is a case where the communication apparatus receives information encrypted by the information processing apparatus based on the information necessary for the wireless setting and the communication apparatus decrypts the encrypted information using a decryption key of the communication apparatus.

19. A method of controlling a communication apparatus operable to communicate with an information processing apparatus, the method comprising:
presenting information necessary for wireless setting to a user based on a condition for entering a state in which the wireless setting for performing wireless communication with the information processing apparatus is able to be started being a first condition,
displaying a screen including information indicating that the wireless setting is able to be started, based on the condition for entering the state in which the wireless setting is able to be started being a second condition different from the first condition, and in response to an instruction of the user, presenting the information necessary for the wireless setting to the user via the screen,
receiving a request for the wireless setting from the information processing apparatus that has obtained connection information based on the information presented based on the condition being the first condition or the information presented in response to the instruction of the user, and
execute the wireless setting in response to the received request.

20. A non-transitory computer-readable storage medium storing a program for causing a processor to execute a method of controlling a communication apparatus operable to communicate with an information processing apparatus, the method comprising:
presenting information necessary for wireless setting to a user based on a condition for entering a state in which the wireless setting for performing wireless communication with the information processing apparatus is able to be started being a first condition,
displaying a screen including information indicating that the wireless setting is able to be started, based on the condition for entering the state in which the wireless setting is able to be started being a second condition different from the first condition, and in response to an instruction of the user, presenting the information necessary for the wireless setting to the user via the screen,
receiving a request for the wireless setting from the information processing apparatus that has obtained connection information based on the information presented based on the condition being the first condition or the information presented in response to the instruction of the user, and
execute the wireless setting in response to the received request.
